(19) United States
(12) Patent Application Publication
(10) Pub. No.: US 2013/0218679 A1
(43) Pub. Date: Aug. 22, 2013

(54) Method, System and Program Product for Providing Advertisement

(71) Applicants: Minzhe Wu, Thousand Oaks, CA (US); Jing Ren, Thousand Oaks, CA (US)

(72) Inventors: Minzhe Wu, Thousand Oaks, CA (US); Jing Ren, Thousand Oaks, CA (US)

(21) Appl. No.: 13/398,629

(22) Filed: Feb. 16, 2012

(51) Int. Cl. G06Q 30/02

(52) U.S. Cl. 705/14.58

(57) ABSTRACT

A method, system and program product comprises registering a provider where the registration comprises an identity, an advertisement, a location for displaying the advertisement, and a time period for an advertising event. Funds are deposited into an account for the advertising event. At least one marketer is registered where the registration comprises an identity, an identity of at least one display and control device in possession of the marketer, a location for the display and control device, and an available time period for displaying advertisement. Notification of a match of a marketer to present advertisement content of a provider is received, in which the provider's advertisement is communicated to the marketer's display and control device. Tracking information for the display and control device determines a value of funds. The value of funds is transferred from the account for the advertising event to an account for the marketer.

### CROSS-REFERENCE TO RELATED APPLICATIONS

Not applicable.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

One or more embodiments of the invention generally relate to communication systems. More particularly, one or more embodiments of the invention relate to communication systems for providing advertisement.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

Advertising is typically carried out via media channels such as newspaper, radio, television and billboard. Companies and organizations that require advertising typically deal with advertising agencies or companies that operate the media channels. Small entities or individual consumers do not have opportunity to participate in the process. In the last decade or so Internet based advertising has been driving the entire industry into a virtual space. The companies and businesses that opt for this virtual space advertising recognize their audience precludes a market segment that spend little or no time on the Internet in their daily life.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a block diagram of an example communication system, in accordance with an embodiment of the present invention;

FIGS. 2A-B are diagrams illustrating example operation of the communication system described with reference to FIG. 1, in accordance with an embodiment of the present invention;

FIG. 3 is a diagram illustrating example operation of the communication system described with reference to FIG. 1, in accordance with an embodiment of the present invention;

FIGS. 4A-E illustrate an example method for the communication system as described with reference to FIGS. 1-3, in accordance with an embodiment of the present invention;

FIG. 5 illustrates a block diagram depicting a conventional client/server communication system; and

FIG. 6 illustrates a typical computer system that, when appropriately configured or designed, may serve as a computer system 600 for which the present invention may be embodied.

Unless otherwise indicated illustrations in the figures are not necessarily drawn to scale.

### DETAILED DESCRIPTION OF SOME EMBODIMENTS

Embodiments of the present invention are best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

A “computer” may refer to one or more apparatus and/or one or more systems that are capable of accepting a structured input, processing the structured input according to prescribed rules, and producing results of the processing as output. Examples of a computer may include: a computer; a stationary and/or portable computer; a computer having a single processor, multiple processors, or multi-core processors, which may operate in parallel and/or not in parallel; a general purpose computer; a supercomputer; a mainframe; a super mini-computer; a mini-computer; a workstation; a micro-computer; a server; a client; an interactive television; a web appliance; a telecommunications device with internet access; a hybrid combination of a computer and an interactive television; a portable computer; a tablet personal computer (PC); a personal digital assistant (PDA); a portable telephone; application-specific hardware to emulate a computer and/or software, such as, for example, a digital signal processor (DSP), a field-programmable gate array (FPGA), an application specific integrated circuit (ASIC), an application specific instruction-set processor (ASIP), a chip, chips, a system on a chip, or a chip set; a data acquisition device; an optical computer; a quantum computer; a biological computer; and generally, an apparatus that may accept data, process data according to one or more stored software programs, generate results, and typically include input, output, storage, arithmetic, logic, and control units.

“Software” may refer to prescribed rules to operate a computer. Examples of software may include: code segments in one or more computer-readable languages; graphical and or/textual instructions; applets; pre-compiled code; interpreted code; compiled code; and computer programs.

A “computer-readable medium” may refer to any storage device used for storing data accessible by a computer. Examples of a computer-readable medium may include: a magnetic hard disk; a floppy disk; an optical disk, such as a CD-ROM and a DVD; a magnetic tape; a flash memory; a memory chip; and/or other types of media that can store machine-readable instructions thereon.

A “computer system” may refer to a system having one or more computers, where each computer may include a computer-readable medium embodying software to operate the computer or one or more of its components. Examples of a computer system may include: a distributed computer system for processing information via computer systems linked by a network; two or more computer systems connected together via a network for transmitting and/or receiving information between the computer systems; a computer system including two or more processors within a single computer; and one or more apparatuses and/or one or more systems that may accept data, may process data in accordance with one or more stored software programs, may generate results, and typically may include input, output, storage, arithmetic, logic, and control units.

A “network” may refer to a number of computers and associated devices that may be connected by communication facilities. A network may involve permanent connections such as cables or temporary connections such as those made through telephone or other communication links. A network may further include hard-wired connections (e.g., coaxial cable, twisted pair, optical fiber, waveguides, etc.) and/or wireless connections (e.g., radio frequency waveforms, free-space optical waveforms, acoustic waveforms, etc.). Examples of a network may include: an internet, such as the Internet; an intranet; a local area network (LAN); a wide area network (WAN); and a combination of networks, such as an internet and an intranet.

Exemplary networks may operate with any of a number of protocols, such as Internet protocol (IP), asynchronous transfer mode (ATM), and/or synchronous optical network (SONET), user datagram protocol (UDP), IEEE 802.x, etc.

Embodiments of the present invention may include apparatuses for performing the operations disclosed herein. An apparatus may be specially constructed for the desired purposes, or it may comprise a general-purpose device selectively activated or reconfigured by a program stored in the device.

Embodiments of the invention may also be implemented in one or a combination of hardware, firmware, and software. They may be implemented as instructions stored on a machine-readable medium, which may be read and executed by a computing platform to perform the operations described herein.

In the following description and claims, the terms “computer program medium” and “computer readable medium” may be used to generally refer to media such as, but not limited to, removable storage drives, a hard disk installed in hard disk drive, and the like. These computer program products may provide software to a computer system. Embodiments of the invention may be directed to such computer program products.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, and as may be apparent from the following description and claims, it should be appreciated that throughout the specification descriptions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

A non-transitory computer readable medium includes, but is not limited to, a hard drive, compact disc, flash memory, volatile memory, random access memory, magnetic memory, optical memory, semiconductor based memory, phase change memory, optical memory, periodically refreshed memory, and the like; however, the non-transitory computer readable medium does not include a pure transitory signal per se.

Some embodiments of the present invention will be described which provide means and methods for a communication system for providing online distribution of advertising content.

In some embodiments, system will provide for an auction process between product/service providers and marketers.

In other embodiments, system will provide for a brokering process between product/service providers and marketers.

In other embodiments, system will provide for marketer selection of advertising for presentation.

In other embodiments, system will provide for product/service provider performing selection of advertising for presentation.

In other embodiments, system will provide for a predetermined unit rate selection methodology.

In some embodiments capability is provide for exchange of currency to tokens and vice-versa. Furthermore, funds may be transferred to/from external financial institutions and establishments (e.g. bank).

In other embodiments, accounting for payments may be performed via exchange of currency.

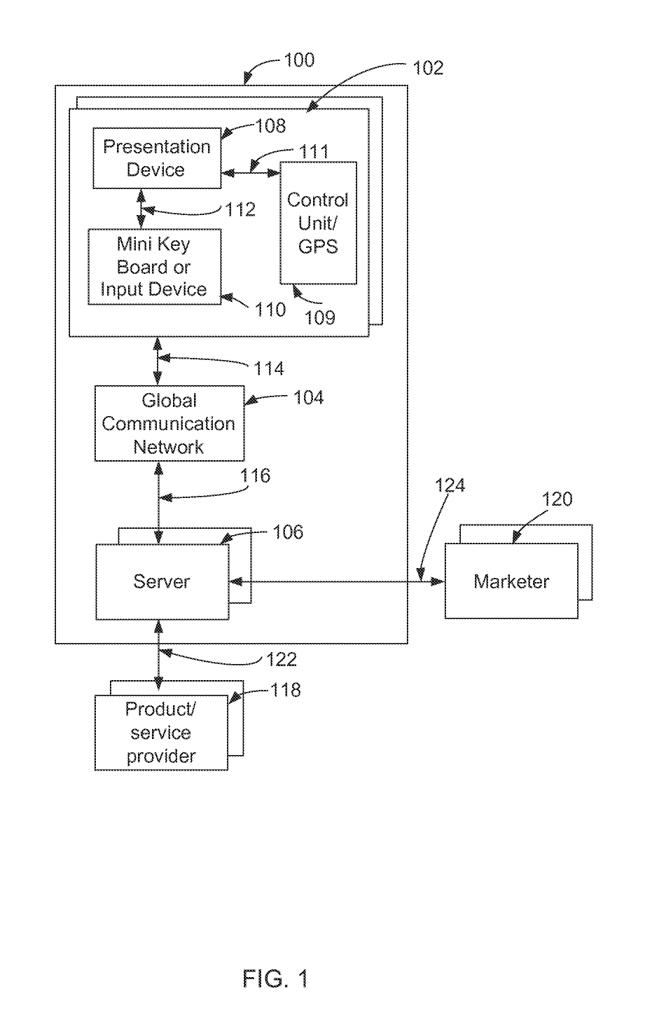

The system will now be described in detail with reference to FIGS. 1-6.

FIG. 1 is a block diagram of an example communication system, in accordance with an embodiment of the present invention.

A communication system 100 includes multiplicity of presentation portions with a sampling noted as a presentation portion 102, a global communication network 104 and a multiplicity of servers with a sampling noted as a server portion 106.

Presentation portion 102 includes a presentation device 108, a control unit 109, and an input device 110. Presentation device 108 communicates bi-directionally with input device 110 via a communication channel 112 and with control unit 109 via a communication channel 111. In some embodiments presentation device 108 and control unit 109 may be configured as a single entity.

Presentation portion 102 communicates bi-directionally with global communication network 104 via a communication channel 114. Global communication network 104 communicated bi-directionally with server portion 106 via a communication channel 116. Server portion 106 communicates bi-directionally with a multiplicity of product/service providers with a sampling noted as a product/service provider 118. Furthermore, server portion 106 communicates bi-directionally with product/service provider via a communication channel 122. Furthermore, server portion 106 communicates bi-directionally with a multiplicity of marketers with a sampling noted as a marketer 120. Furthermore, server portion 106 communicates bi-directionally with marketer 120 via a communication channel 124.

Presentation portion 102 provides capability for receiving and presenting information and for configuring presentation portion 102. Presentation portion 102 may be configured with GPS for tracking and verifying geographic location associated with advertisement presentation. Furthermore, presentation portion 102 may be configured with time keeping capability for tracking time associated with presentation of advertisements.

Global communication network 104 provides bi-directional communication for a multiplicity of entities.

Server portion 106 receives, stores, updates, retrieves and processes information. As a non-limiting example, server portion 106 may provide a website interface for interacting with users and potential users. As another non-limiting example, server portion 106 may provide an Application Programming Interface (API) for interfacing with other computing and/or communication devices to receive, store, update, retrieve and process information. As a non-limiting example, server portion 106 provides capability for distribution of advertising content, algorithms for allocation of advertisements based upon preferences of marketers 120 and product/service provider 118 and upon other factors such as the content of the associated advertisement. As a non-limiting example, server portion 106 provides capability for a token system used for payment associated with advertising. As a non-limiting example, token system may be configured to support product/service provider account, marketer account and advertising event account. Furthermore, token system may be configured for a denomination differential between product/service provider account and marketer account (e.g. tokens sold to product/service provider at a higher price than the price as redeemed by marketers). Furthermore, the price differential may represent revenue to proprietor associated with communication system 100. In some embodiments, tokens are transferred to marketer account from product/service provider by way of advertising event account where advertising account operates as an escrow account. Product/service provider may purchase tokens with tokens deposited into advertising event account. Following performance of advertising by marketers, marketers may submit tracking information in exchange for tokens with received tokens placed into marketer account. Tokens may be valued at less than $0.01 in order to provide resolution to the second for presented advertisements and for competitive bidding.

Product/service provider 118 provides products and services associated with commerce. Furthermore, product/service provider 118 may seek to advertise associated products and services to consumers, businesses and other entities. Product/service provider 118 may provide advertising associated with product/services via a variety of formats and specifications. Non-limiting examples of formats include text, images, pictures, video or Internet website. Non-limiting examples of specifications associated with advertisements include geographic region, time, price and the quantity of marketers accepted. As a non-limiting example, price may be the advertising fee to be paid to marketers. Furthermore, as a non-limiting example, payment for advertising may be performed as a lump sum, by region and time period. As a non-limiting example, the quantity of accepted marketers may be provided by product/service provider 118 or allocated by server portion 106. Furthermore, allocation by server portion 106 may be performed based upon payment of fees, time, geographic region and marketers preferences.

Marketer 120 provides marketing of products and services associated with commerce. Furthermore, marketer 120 may provide avenues for advertising to entities seeking to advertise their products and services. As a non-limiting example, marketer 120 may market and advertise products and services associated with product/service provider 118. As another non-limiting example, marketer 120 may have ownership or other association with presentation portion 102. As another non-limiting example, marketer 120 may provide geographic location information associated with presentation portion 102. As another non-limiting example, marketer 120 may provide marketing for marketing products and services associated with product/service provider 118 to targeted market segments via presentation device 108 attached to an automobile (e.g. rental car, taxi, etc.). Marketer 120 may select to bid on advertisements provided by product/service provider 118. As a non-limiting example, selection of bidding may be competitively based. As a non-limiting example, marketer 120 selected for presenting advertisements may provide the advertisements via associated presentation portion 102. Furthermore, marketer 120 may receive compensation in exchange for presenting advertisements. Non-limiting examples of compensation in include currency, credits and coupons.

Presentation device 108 provides capability for receiving and presenting information. As a non-limiting example, presentation device 108 may be configured as an electronic sign. As a non-limiting example, presentation device 108 may present information associated with advertising products and services. As another non-limiting example, presentation device 108 may present instant messages such as “Novice Driver”, “May I cut in?” and “Thank You!” from one operator of an automobile to other operators of automobiles. As another non-limiting example, presentation device 108 may present information received via a global network and/or wireless communication network associated with advertiser content, road hazards and other emergency messages. As another non-limiting example, presentation device 108 may present information for personalizing devices such as presenting images of family members associated with an automobile. Non-limiting examples of information presented by presentation device 108 include dynamic illustrations of letters, words, signs, numbers, images and videos. Non-limiting examples for geographic location of presentation device 108 include the exterior of automobiles, transportation vehicles, buses, trains and other stationary or moving objects. As a non-limiting example, presentation device 108 may be configured as a thin layer of bendable electronic presentation screen. Non-limiting examples for stationary placement of presentation device 108 include house roof top, sign poles, buildings, highways, shopping malls and other real-estate properties. Presentation device 108 may be installed by authorized dealers and/or service centers.

Control unit 109 receives information for presentation from external entities and from input device 110. Control unit 109 may communicate with global communication network 104. As a non-limiting example, control unit 109 may communicate with global communication network 104 via a wired or wireless network. Furthermore, control unit 109 may receive information from a computing device with bi-directional communication capability with global communication network 104. Furthermore, control unit 109 may download advertising content for presentation via presentation device 108. Furthermore, control unit 109 may upload information to server portion 106 via global communication network 104. Non-limiting examples of uploaded information include marketer identification, time, date and geographic location for presentations of advertising. Non-limiting examples for control unit 109 include cellular telephone, tablet computing device with installed control application and dedicated standalone computing device. Control unit 109 may receive and process GPS information in order to ensure the operation of presentation device 108 with respect to public and private geographic location is accurately communicated. As a non-limiting example, control unit 109 tracks geographic location, time and date associated with advertising using embedded encryption processing and associated algorithms.

Input device 110 receives information. Non-limiting examples for input device 110 include alphanumeric keyboard and pointing device. As a non-limiting example, input device 110 may communicate via communication channel 112 with presentation device 108 via wired or wireless connection. As a non-limiting example, input device may provide short-cut keys for commonly used messages (e.g. “Thank You!”). As a non-limiting example, input device 110 may be used for selecting and downloading information for presentation (e.g. images, videos, etc.) via global communication network 104. As another non-limiting example, input device 110 may be configured as a mobile cellular telephone for receiving road hazard information and other emergency messages for presentation via presentation device 108. As another non-limiting example, input device 110 may be configured as a Global Positing Satellite (GPS) device for communicating information associated with travel and for receiving timing information (e.g. time-of-day, date, year, etc.).

FIG. 1 is a block diagram of an example communication system where product/service providers may advertise their products via marketers and associated presentation devices.

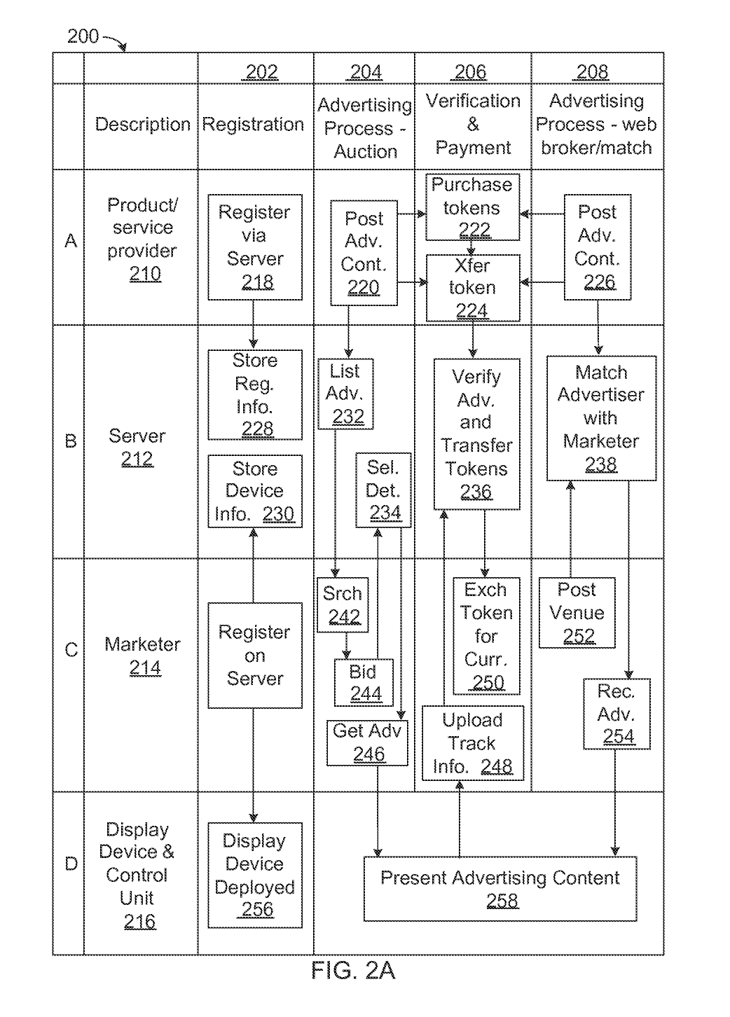

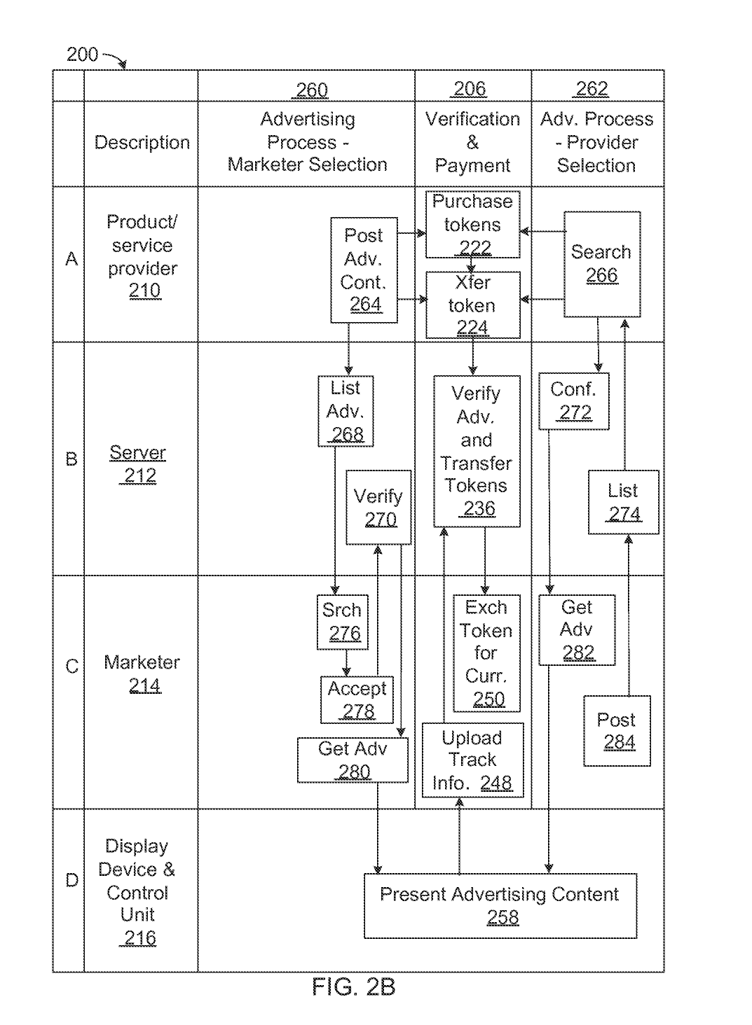

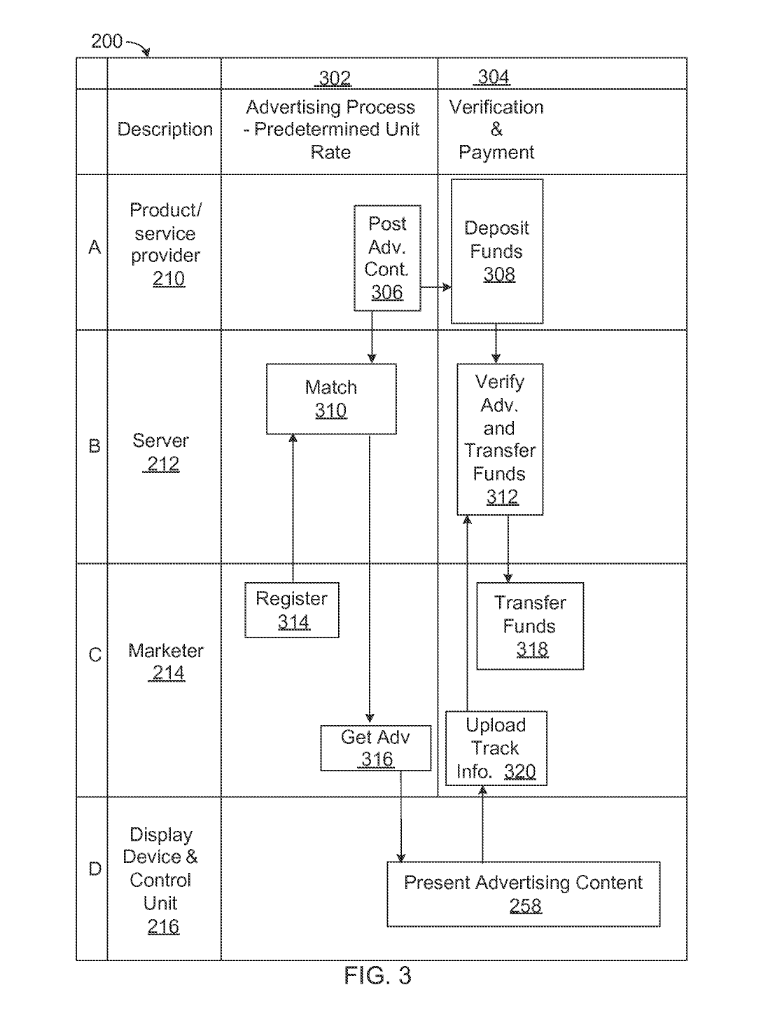

FIG. 2A is a diagram illustrating example operation of the communication system described with reference to FIG. 1, in accordance with an embodiment of the present invention.

A diagram 200 includes a registration column 202, an advertising process—auction column 204, a verification/payment column 206, an advertising process—website brokering/matching column 208, a product/service provider row 210, a server row 212, a marketer row 214 and a presentation device row 216.

Registration column 202 illustrates functions associated with registering. Advertising process—auction column 204 illustrates functions associated with advertising auctions. Verification/payment column 206 illustrates functions associated with verification and payments. Advertising process—website brokering/matching column 208 illustrates functions associated with broker advertising processes. Product/service provider row 210 illustrates functions associated with product/service provider 118 described with reference to FIG. 1. Server row 212 illustrates functions associated with server portion 106 described with reference to FIG. 1. Marketer row 214 illustrates functions associated with marketer 120 described with reference to FIG. 1. Presentation device row 216 illustrates functions associated with presentation portion 102 described with reference to FIG. 1.

Product/service provider row 210 includes a register function 218, a post advertisement function 220, a purchase tokens function 222, a transfer token function 224 and a post advertisement function 226.

Server row 212 includes a store registration function 228, a store device information function 230, a list advertisements function 232, a selection determination function 234, a verification/transfer function 236 and a match function 238.

Marketer row 214 includes a register function 240, a search function 242, a bid function 244, a download advertisement function 246, an upload tracking information function 248, an exchange token function 250, a post venue function 252 and a receive advertisement function 254.

Presentation device row 216 includes a presentation device deployed function 256 and a present advertising function 258.

Registration column 202 includes register function 218, store registration function 228, store device information function 230, register function 240 and presentation device deployed function 256.

Advertising process auction column 204 includes post advertisement function 220, list advertisements function 232, selection determination function 234, search function 242, bid function 244, download advertisement function 246 and present advertising function 258.

Verification/payment column 206 includes purchase tokens function 222, transfer token function 224, verification/transfer function 236, upload tracking information function 248, exchange token function 250 and present advertising function 258.

Advertising process—Website Brokering/Matching column 208 includes post advertisement function 226, match function 238, post venue function 252, receive advertisement function 254 and present advertising function 258.

Register function 218 provides capability for registering. Non-limiting examples of information received for register function 218 include login credentials (e.g. user identification, password, etc.), entity associated information (e.g. company identifier), advertising needs, target market and funding source.

Post advertisement function 220 provides capability for product/service provider 118 (FIG. 1) to post advertising information to server portion 106 (FIG. 1). Non-limiting examples of information posted by product/service provider 118 (FIG. 1) include advertising content, description of advertising content, date, time, geographic location for advertising, quantity of presentation device 108 (FIG. 1) needed and compensation associated information.

Purchase tokens function 222 provides capability for purchasing tokens and depositing tokens associated with an account. As a non-limiting example, tokens may be used for purchasing advertisement of products and services. As another non-limiting example, tokens may be purchased at a higher denomination value than the redemption value.

Transfer token function 224 provides capability for transferring tokens from one account to an advertising associated account.

Post advertisement function 226 provides capability for product/service provider 118 (FIG. 1) to post advertising information to server portion 106 (FIG. 1). Non-limiting example of information posted include advertising content, description of advertising content, date, time, geographic location for placement of advertising, quantity of presentation device 108 (FIG. 1) needed and compensation associated information.

Store registration function 228 provides capability for server portion 106 (FIG. 1) to store product/service provider 118 (FIG. 1) registration information with server portion 106 (FIG. 1).

Store device information function 230 provides capability to store registration information associated with presentation device 108 (FIG. 1), marketer 120 (FIG. 1) and presentation portion 102 (FIG. 1).

List advertisements function 232 provides capability to list product/service provider 118 (FIG. 1) advertisement requests via server portion 106 (FIG. 1) for search by marketer 120 (FIG. 1).

Selection determination function 234 provides capability to select marketer 120 (FIG. 1) for performing advertising. As a non-limiting example, selection may be performed for lower bids associated with an auction. As a non-limiting example, server portion 106 (FIG. 1) may sort marketer 120 (FIG. 1) based upon lower to higher compensation bids. As a non-limiting example, selection may be performed for qualified marketers with lower bids up to quantity of marketers needed by product/service provider 118 (FIG. 1).

Verification/transfer function 236 provides capability to perform verification and transfer of tokens associated with advertising. Server portion 106 (FIG. 1) provides verification associated with presentation of advertising and transfers tokens from advertising event account to marketer 120 (FIG. 1) account.

Match function 238 provides capability to match product/service provider 118 (FIG. 1) with marketer 120 (FIG. 1) based upon submitted information. Server portion 106 (FIG. 1) performs matching operation and informs product/service provider 118 (FIG. 1) and marketer 120 (FIG. 1) of a match.

Register function 240 provides capability to register marketer 120 (FIG. 1). Non-limiting examples of information provided for registering include login credentials (e.g. user identification, password, etc.) user associated information (e.g. name, etc.), geographic location, available advertising time/date, advertising content of interest and bank account information.

Search function 242 provides capability for marketer 120 (FIG. 1) to search advertisement listings associated with product/service provider 118 (FIG. 1). Non-limiting examples of information needed by marketer 120 (FIG. 1) for bidding include geographic location and available time/date.

Bid function 244 provides capability for marketer 120 (FIG. 1) to submit bids for advertising. Non-limiting examples of information associated with bids include quantity of available presentation device 108 (FIG. 1) and compensation information.

Download advertisement function 246 provides capability for marketer 120 (FIG. 1) to download advertisement information associated with selected advertisements. As a non-limiting example, marketer 120 (FIG. 1) downloads advertising information and communicates advertising associated information to presentation portion 102 (FIG. 1). As another non-limiting example, marketer 120 (FIG. 1) may communicate information to presentation portion 102 (FIG. 1) via wireless communication network.

Upload tracking information function 248 provides capability for marketer 120 (FIG. 1) and/or presentation portion 102 (FIG. 1) to upload tracking information associated with presentation of advertisements to server portion 106 (FIG. 1).

Exchange token function 250 provides capability for marketer 120 (FIG. 1) to exchange tokens for currency to be transferred to an associated marketer 120 (FIG. 1) bank account.

Post venue function 252 provides capability for marketer 120 (FIG. 1) to post information associated with advertisement of interest. Non-limiting examples of information associated with advertisement of interest include available time/date, geographic location, quantity of presentation device 108 (FIG. 1) and compensation.

Receive advertisement function 254, associated with marketer 120 (FIG. 1), downloads or configures presentation portion 102 (FIG. 1) with advertisement information. As a non-limiting example, advertising information may be communicated to presentation portion 102 (FIG. 1) via a wireless network.

For presentation device deployed function 256 marketer 120 (FIG. 1) configures devices (e.g. automobile) with capability for presenting advertisements. As a non-limiting example, devices may be configured by authorized dealers or installation establishments.

Present advertising function 258 provides capability to present advertising via presentation device 108 (FIG. 1). Control unit 109 (FIG. 1) communicates information to be presented by presentation device 108 (FIG. 1). Furthermore, control unit 109 (FIG. 1) tracks geographic location and time/date associated with advertisement presentation. Control unit (FIG. 1) converts collected information associated with advertising into location, time/date and other information. Non-limiting examples of other information include descriptors such as “freeway”, “mall parking lot”, city, state, zip code and quantity of minutes advertising is presented. Furthermore, descriptors presented to server portion 106 (FIG. 1) may be noted in such a way as to protect the privacy of participants presenting advertisements. As a non-limiting example, advertising presented associated with non-public geographic areas may not be considered toward minutes of advertising presented.

Server portion 106 (FIG. 1) accepts product/service provider 118 (FIG. 1) as a user. Furthermore, server portion 106 (FIG. 1) accepts advertising needs associated with advertising products/services associated with product/service provider 118 (FIG. 1). Server portion 106 (FIG. 1) distributes the advertising content associated with product/service provider 118 (FIG. 1) to marketer 120 (FIG. 1). Furthermore, as a non-limiting example, server portion 106 (FIG. 1) may distribute advertising content to marketer 120 (FIG. 1) based upon interests of marketer 120 (FIG. 1) and/or monetary compensation for marketer 120 (FIG. 1). Furthermore, server portion 106 (FIG. 1) may distribute advertising content based upon the capabilities associated with marketer 120 (FIG. 1).

Product/service provider 118 (FIG. 1) seeks to advertise products and services via a quantity of presentation device 108 (FIG. 1) associated with marketer 120 (FIG. 1). Marketer 120 (FIG. 1) owns, rents or otherwise provides presentation device 108 for presenting advertising. Product/service provider 118 (FIG. 1) registers with server portion 106 (FIG. 1) via register function 218. In order to register, product/service provider 118 (FIG. 1) provides information needed for registration and capability for funding advertising (e.g. credit card, bank account, etc). Following registration, product/service provider 118 (FIG. 1) may purchase tokens via purchase tokens function 222. As a non-limiting example, product/service provider 118 (FIG. 1) may purchase a 1000 tokens for a $1.01. Furthermore, tokens may be used for purchasing advertising from marketer 120 (FIG. 1) for presentation via presentation device 108 (FIG. 1).

Marketer 120 (FIG. 1) may register with server portion 106 (FIG. 1) via register function 240. Furthermore, marketer 120 (FIG. 1) may provide presentation of advertising via presentation device 108 (FIG. 1). Non-limiting examples for placement of advertising include automobiles and real estate. Marketer 120 (FIG. 1) may request or bid on presentation of advertising content provided by product/service provider 118 (FIG. 1). Marketer 120 (FIG. 1) may requisition presentation device 108 (FIG. 1) via authorized dealers or installation establishments via presentation device deployed function 256. Presentation device 108 (FIG. 1) may be configured in such a way as to be visible by third parties.

Allocation operation performed by server portion 106 (FIG. 1) receives and processes information for matching product/service provider 118 (FIG. 1) and marketer 120 (FIG. 1). Non-limiting examples of information processed via server portion 106 include advertising time, cost, geographic location, quantity of marketer 120 (FIG. 1), quantity of presentation device 108 (FIG. 1) and content preferences of marketer 120 (FIG. 1).

Communication system 100 (FIG. 1) may be configured in a variety architectures. Non-limiting examples for architectures of communication system 100 (FIG. 1) include auction/bidding, marketer selection, product/service provider selection, (marketer or product/service provider selection architectures may be viewed as a typical “purchase” experience), broker/dealer and predetermined unit rate via broker/dealer.

An example of the auction/bidding architecture is illustrated via advertising process auction column 204. Product/service provider 118 (FIG. 1) posts advertising content or a description of the advertising content to server portion 106 (FIG. 1) as illustrated with reference to post advertisement function 220. Furthermore, product/service provider 118 (FIG. 1) posts geographic area, geographic location, time, compensation per unit of time and quantity of presentation device 108 (FIG. 1) requested. Marketer 120 (FIG. 1) may adjust and associated bid for advertising content posted by product/service provider 118 (FIG. 1) as illustrated with reference to bid function 244. Following the auction operation, server portion 106 (FIG. 1) matches the quantity of presentation device 108 (FIG. 1) requested by product/service provider 118 (FIG. 1) with the lower compensation bids as illustrated with reference to selection determination function 234.

For advertising of its products/services, product/service provider 118 may post advertising content and associated requirements (e.g. date, time, geographic location, quantity of needed presentation devices, compensation, etc.) to server portion 106. Furthermore, product/service provider 118 (FIG. 1) may purchase and deposit sufficient tokens to cover the cost associated with executing the advertisement with the token acquisition performed via purchase tokens function 222. Server portion 106 (FIG. 1) presents a list of advertising requests associated with product/service provider 118 (FIG. 1) to marketer 120 (FIG. 1) performed via search function 242.

A qualified marketer 120 (FIG. 1) may submit bids for performing advertising via bid function 244. Non-limiting examples of constraints qualifying marketer 120 (FIG. 1) include targeted geographic location, available presentation devices and available time slots. As a non-limiting example, marketer 120 (FIG. 1) may submit a bid of 100 tokens per minute of advertisement presentation.

Following the auction process, server portion 106, via selection determination function 234, matches a quantity of presentation device 108 (FIG. 1) to the number needed by product/service provider 118 (FIG. 1) ranked by lower compensation bids. As a non-limiting example, the results of an auction may have hundreds or thousands of selected marketer 120 (FIG. 1).

Selected marketer 120 (FIG. 1) may be notified of selection for performing advertising. Non-limiting examples for performing notification include email and text message. Furthermore, selected marketer 120 (FIG. 1) may download content via download advertisement function 246 to control unit 109 (FIG. 1). Non-limiting examples for communication of content include wireless, cellular phone network, computing device or via global communication network. As a non-limiting example, content may be automatically communicated to control unit 109 (FIG. 1) for presentation via presentation device 108 (FIG. 1).

Marketer 120 (FIG. 1) may bid for advertising per time slots available with respect to presentation device 108 (FIG. 1). As a non-limiting example, marketer 120 (FIG. 1) may bid for one hour associated with an advertising event and another hour associated with a different advertising event or alternatively may bid for two hours for associated with an advertising event.

As a non-limiting example, advertising content via present advertising function 258 may be presented for viewing via presentation device 108 (FIG. 1). Furthermore, advertising content is communicated from control unit 109 (FIG. 1) to presentation device 108 (FIG. 1).

For present advertising function 258, control unit 109 (FIG. 1) logs time associated with presentation of advertising. Furthermore, control unit 109 (FIG. 1) logs time associated with no presentation of advertising. Furthermore, control unit 109 (FIG. 1) converts GPS geographic location information to generalized location information for use in calculating earnings associated with presentation of advertising.

Following presentation of advertising, information associated with the presentation of advertising may be communicated from control unit 109 (FIG. 1) to server portion 106 via upload tracking information function 248. Non-limiting examples of information communicated include marketer identification, advertising event identification, geographic location and time associated with presentation of advertising. Based upon information associated with presentation of advertising, tokens are transferred via verification/transfer function 236 from product/service provider 118 (FIG. 1) account to marketer 120 (FIG. 1) account.

Marketer 120 may exchange tokens for currency via exchange token function 250. Furthermore, currency may be transferred to a bank account associated with marketer 120 (FIG. 1). A non-limiting example for exchange token function 250 is the exchange of 1000 tokens for $1.00. As a non-limiting example for illustrating profit for communication system 100 (FIG. 1), product/service provider may pay $1.01 for tokens used for presentation of advertising with $1.00 worth of tokens transferred to the marketer. The amount represented by the subtraction of $1.00 from $1.01 or $0.01 represents revenue generated by communication system 100 (FIG. 1).

FIG. 2A is a diagram illustrating example operation of the communication system described with reference to FIG. 1 where product/service providers and marketers interact for presenting advertisements associated with product/service providers via marketer's associated presentation devices.

FIG. 2B is a diagram illustrating example operation of the communication system described with reference to FIG. 1, in accordance with an embodiment of the present invention.

Diagram 200 includes an advertising process column 260, verification/payment column 206, an advertising process column 262, product/service provider row 210, server row 212, marketer row 214 and presentation device row 216.

Product/service provider row 210 includes a post advertising function 264, purchase tokens function 222, transfer token function 224 and a search function 266.

Server row 212 includes a list advertisement function 268, a verify function 270, verification/transfer function 236, a confirmation function 272 and a list function 274.

Marketer row 214 includes a search function 276, an acceptance function 278, a download advertisement 280, upload tracking information function 248, exchange token function 250, a download advertisement function 282 and a post advertisement function 284.

Presentation device row 216 includes present advertising function 258.

Advertising process column 260 includes post advertising function 264, list advertisement function 268, verify function 270, search function 276, acceptance function 278, download advertisement 280 and present advertising function 258.

Advertising process column 262 includes search function 266, confirmation function 272, list function 274, download advertisement function 282, post advertisement function 284 and present advertising function 258.

Post advertising function 264 provides capability for product/service provider 118 (FIG. 1) to provide advertising content for presentation. Non-limiting examples of information associated with advertising content include advertising content, description of advertising content, date, time, geographic location for advertising presentation, quantity of devices needed and compensation.

Search function 266 provides capability for product/service provider 118 (FIG. 1) to search for marketer 120 (FIG. 1) listings meeting advertising needs (e.g. geographic location and time/date). Furthermore, product/service provider 118 (FIG. 1) may select via server portion 106 (FIG. 1) to accept marketer 120 (FIG. 1) with acceptable constraints. A non-limiting example of acceptable constraint is compensation needed by marketer 120 (FIG. 1) for presenting advertisements.

List advertisement function 268 provides capability for listing product/service provider 118 (FIG. 1) advertisement requests and providing capability for searching list via marketer 120 (FIG. 1).

Verify function 270 provides capability via server portion 106 (FIG. 1) for verifying marketer 120 (FIG. 1) acceptance with respect to product/service provider 118 (FIG. 1) advertising request. Furthermore, server portion 106 (FIG. 1) verifies advertising event is not oversubscribed by marketer 120 (FIG. 1). Furthermore, server portion 106 (FIG. 1) provides confirmation to product/service provider 118 (FIG. 1) and to marketer 120 (FIG. 1) following performance of verification.

Confirmation function 272 provides capability via server portion 106 for confirmation of a match associated with product/service provider 118 (FIG. 1) and marketer 120 (FIG. 1).

List function 274 provides capability for listing marketer 120 (FIG. 1) via server portion 106 (FIG. 1) for providing search capability to product/service provider 118 (FIG. 1).

Search function 276 provides capability for marketer 120 (FIG. 1) to search advertising listing associated with product/service provider 118 (FIG. 1). As a non-limiting example, advertisement requirements need to be met by marketer 120 (FIG. 1) prior to acceptance function may be provided. Non-limiting examples of advertisement requirements include location and available time.

Acceptance function 278 provides capability for marketer 120 (FIG. 1) to accept advertisement and provide an indication of the quantity of available presentation device 108 (FIG. 1).

Download advertisement 280 provides capability for marketer 120 (FIG. 1) to download advertising content to presentation portion 102 (FIG. 1). Furthermore, advertising content may be provided to presentation portion 102 (FIG. 1) via wireless network.

Download advertisement function 282 provides capability for marketer 120 (FIG. 1) to download advertising content to presentation portion 102 (FIG. 1). Furthermore, advertising content may be provided to presentation portion 102 (FIG. 1) via wireless network.

Post advertisement function 284 provides capability for marketer 120 (FIG. 1) to post advertising interest to server portion 106 (FIG. 1). Non-limiting examples of advertising interest information include advertising content, available date/time, geographic location, quantity of presentation device 108 (FIG. 1) available and compensation.

An example of the purchase architecture is illustrated via advertising process column 260. The purchase process may be initiated via product/service provider 118 as described with reference to advertising process column 260 or via marketer 120 (FIG. 1) as described with reference to advertising process column 262.

For purchase by marketer 120 (FIG. 1), product/service provider 118 (FIG. 1) needing presentation of advertising information posts advertising content and/or description of the content as described with reference to post advertising function 264. Non-limiting examples of information posted to server portion 106 (FIG. 1) by product/service provider 118 (FIG. 1) include required geographic location, time, date, quantity of presentation device 108 (FIG. 1) needed and compensation. Furthermore, marketer 120 (FIG. 1) meeting specifications for advertisement may download and present the advertising content to associated presentation device 108 (FIG. 1) as described with reference to search function 276, acceptance function 278, download advertisement 280 and present advertising function 258.

For purchase by product/service provider 118 (FIG. 1), marketer 120 (FIG. 1) seeking to present advertising posts information associated with advertising capabilities to server portion 106 (FIG. 1) as described with reference to post advertisement function 284. Non-limiting examples of information posted include geographic location, quantity of presentation device 108 (FIG. 1) available, available time period, available date and compensation. Then product/service provider 118 (FIG. 1) seeking to present advertising content may search for and may purchase or lease time slots associated with presentation device 108, per the associated compensation, for respective marketer 120 (FIG. 1) as described with reference to search function 266. Following confirmation by server portion 106 (FIG. 1), as described with reference to confirmation function 272, marketer 120 (FIG. 1) may download advertising content as described with reference to download advertisement function 282 and may present advertising as described with reference to present advertising function 258.

An example of broker/dealer architecture is illustrated via advertising process column 208. Product/service provider 118 (FIG. 1) as described with reference to post advertisement function 226 and/or marketer 120 as described with reference to post venue function 252 may submit information to server portion 106 (FIG. 1). Non-limiting examples of information posted include advertising content, geographic location, time period, date, quantity of available presentation device 108 (FIG. 1) and compensation. Based upon the information provided by product/service provider 118 (FIG. 1) and marketer 120 (FIG. 1), server portion 106 (FIG. 1) determines matches as described with reference to match function 238.

FIG. 2B is a diagram illustrating example operation of the communication system described with reference to FIG. 1 where product/service providers and marketers interact for presenting advertisements associated with product/service providers via marketer's associated presentation devices.

FIG. 3 is a diagram illustrating example operation of the communication system described with reference to FIG. 1, in accordance with an embodiment of the present invention.

Diagram 200 includes an advertising process column 302, a verification/payment column 304, product/service provider row 210, server row 212, marketer row 214 and presentation device row 216.

Product/service provider row 210 includes a post advertising function 306 and a deposit funds function 308.

Server row 212 includes a match function 310 and a verify function 312.

Marketer row 214 includes a register function 314, a download advertising function 316, a transfer funds function 318 and an upload tracking information 320.

Presentation device row 216 includes present advertising function 258.

Advertising process column 302 includes post advertising function 306, match function 310, register function 314, download advertising function 316 and present advertising function 258.

Predetermined broker/dealer architecture may be implemented via advertising process column 302 where a predetermined advertising compensation rate (e.g. $0.05 per minute of presentation device 108 (FIG. 1) presenting advertisement) is specified. Product/service provider 118 (FIG. 1) as described with reference to post advertisement function 306 and/or marketer 120 as described with reference to register function 314 may submit information to server portion 106 (FIG. 1). Non-limiting examples of information posted include advertising content, geographic location, time period, date and quantity of available presentation device 108 (FIG. 1). Based upon the information provided by product/service provider 118 (FIG. 1) and marketer 120 (FIG. 1), server portion 106 (FIG. 1) determines matches as described with reference to match function 310.

Verification/payment column 304 includes deposit funds function 308, verify function 312, transfer funds function 318, upload tracking information 320 and present advertising function 258.

Post advertising function 306 provides capability for product/service provider 118 (FIG. 1) to submit advertising content to server portion 106 (FIG. 1). Non-limiting examples of information posted in association with advertising content include description of advertising content, date/time, geographic location and quantity of presentation device 108 (FIG. 1) needed.

Deposit funds function 308 provides capability for product/service provider 118 (FIG. 1) to deposit funds to advertising event account.

Match function 310 provides capability via server portion 106 for performing matches between product/service provider 118 (FIG. 1) and marketer 120 (FIG. 1). Non-limiting examples of information used for generating match include advertising location, time/date, marketer 120 (FIG. 1) interest and quantity of presentation device 108 available. As a non-limiting example, server portion 106 (FIG. 1) determines the unit cost of advertising. Furthermore, cost of advertising may be performed based upon per presentation device 108 (FIG. 1) and per minute of advertising presented.

Verify function 312 provides capability for verifying via server portion 106 (FIG. 1) tracking data associated with advertising. Furthermore, following verification, funds may be transferred from advertising event account and transferred to account associated with marketer 120 (FIG. 1).

Register function 314 provides capability for marketer 120 (FIG. 1) to register presentation device 108 (FIG. 1) and presentation portion 102 (FIG. 1) with server portion 106 (FIG. 1). Non-limiting examples of information provide for registering include interest area of advertising content, available date/time and geographic location.

Download advertising function 316 provides capability for marketer 120 (FIG. 1) to download advertising content to presentation portion 102 (FIG. 1). Furthermore, advertising content may be communicated from server portion 106 (FIG. 1) to presentation portion 102 (FIG. 1) via wireless network.

Transfer funds function 318 provides capability for marketer 120 (FIG. 1) to transfer funds to bank account associated with marketer 120 (FIG. 1).

Upload tracking information 320 provides capability for marketer 120 (FIG. 1) to upload advertising tracing information from presentation portion 102 (FIG. 1) to server portion 106 (FIG. 1). Furthermore, upload of information may be performed automatically by presentation portion 102 (FIG. 1).

Non-limiting examples of allocation processing performed via server portion 106 (FIG. 1) include selection determination function 234 (FIG. 2A), match function 238 (FIG. 2A), verify function 270 (FIG. 2B), confirmation function 272 (FIG. 2B) and match function 310 (FIG. 2B).

FIG. 3 is a diagram illustrating example operation of the communication system described with reference to FIG. 1 where product/service providers and marketers interact for presenting advertisements associated with product/service providers via marketer's associated presentation devices.

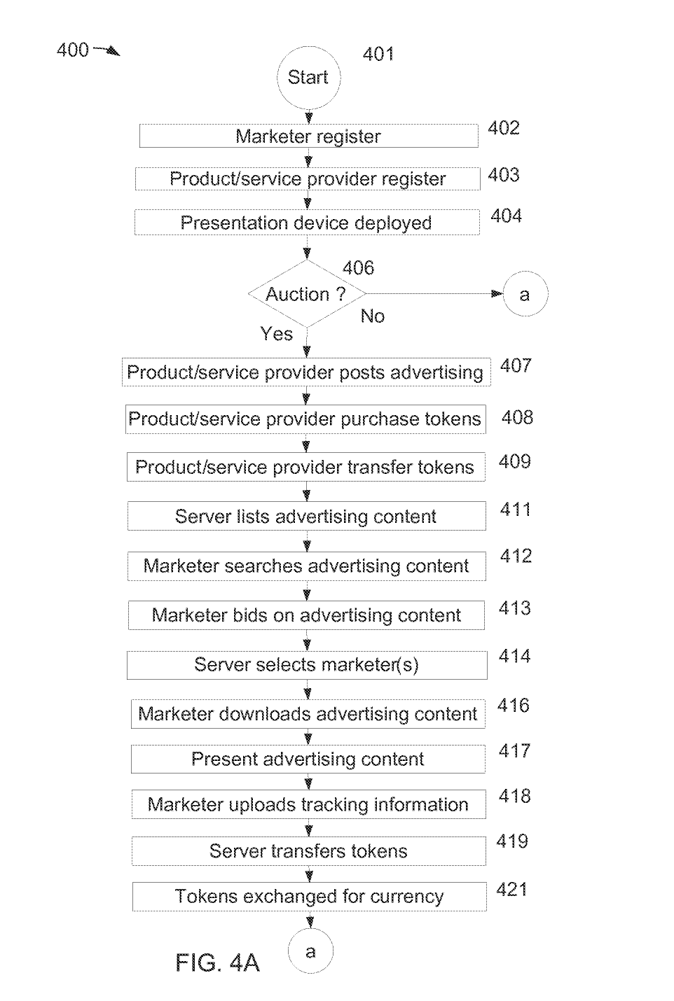

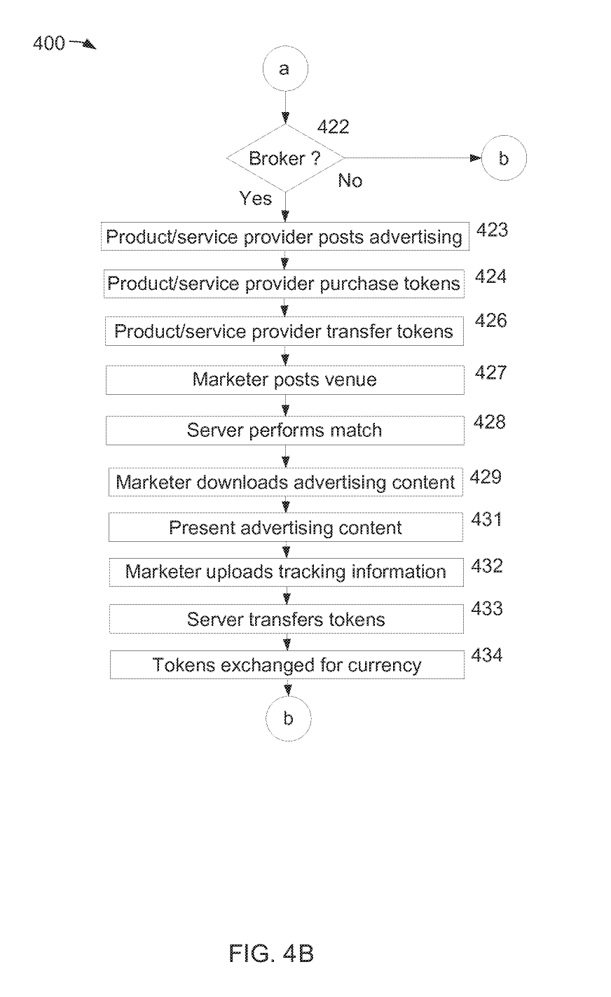

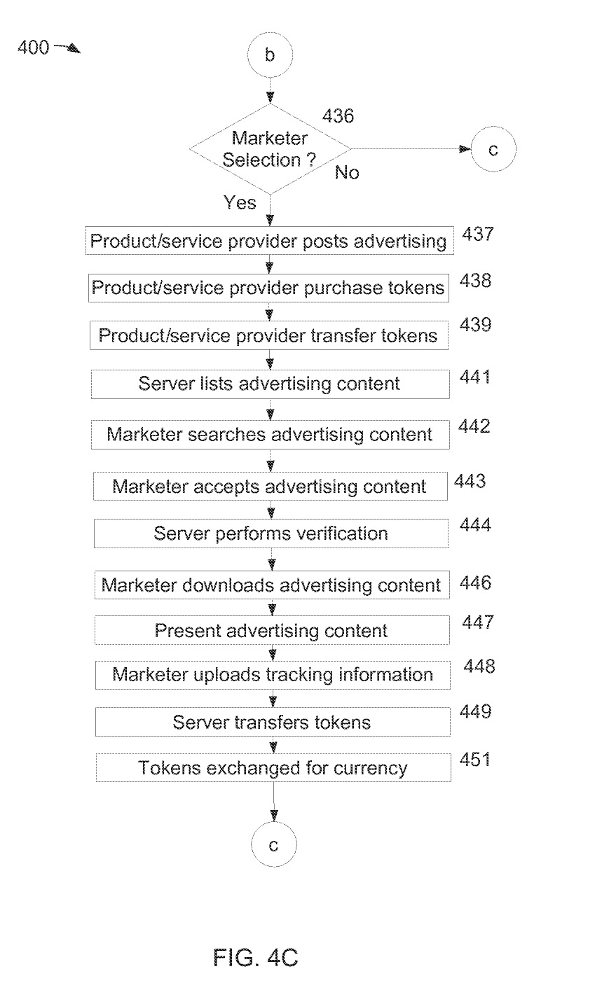

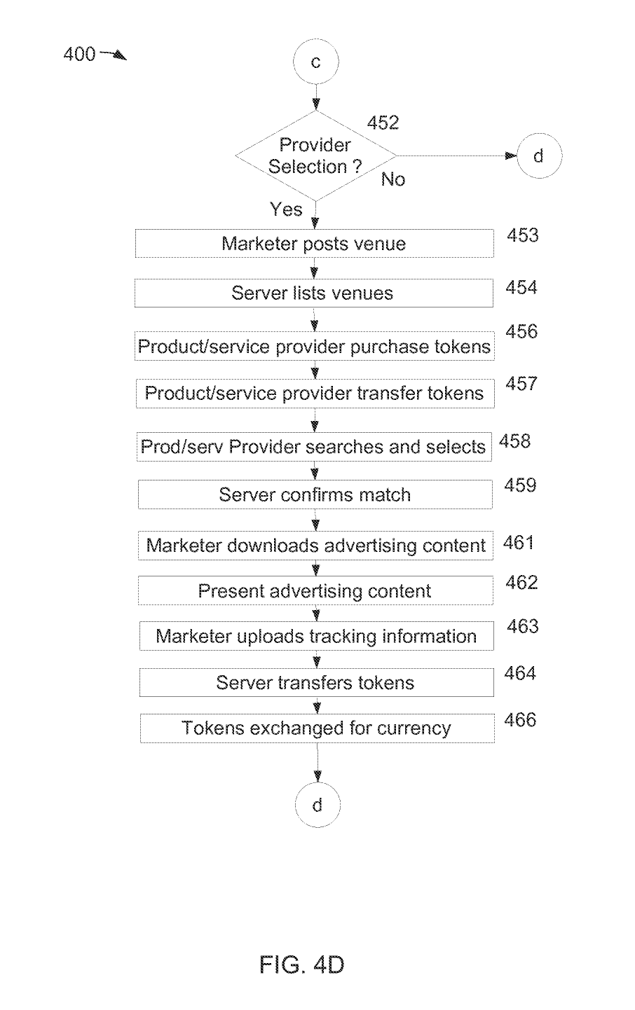

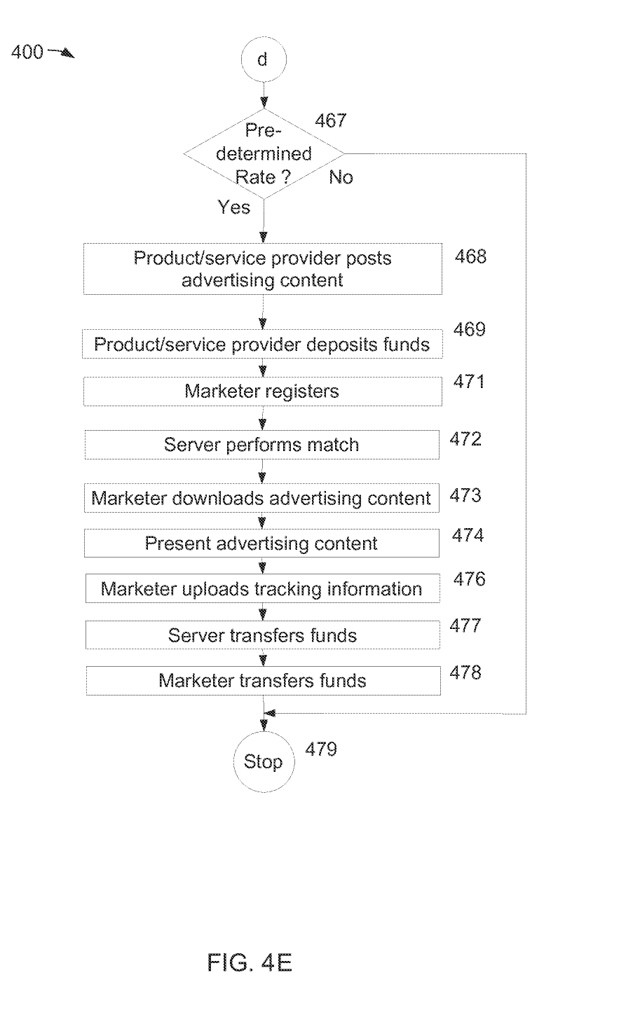

FIGS. 4A-E illustrate an example method for the communication system as described with reference to FIGS. 1-3, in accordance with an embodiment of the present invention.

Referring to FIG. 4A, a method 400 initiates in a step 401.

Then in a step 402, marketer 120 (FIG. 1) registers with server portion 106 (FIG. 1) as described with reference to register function 240 (FIG. 2A) and store device information function 230 (FIG. 2A).

Then in a step 403, product/service provider 118 (FIG. 1) registers with server portion 106 (FIG. 1) as described with reference to register function 218 (FIG. 2A) and store registration function 228 (FIG. 2A).

Then in a step 404, presentation device 108 (FIG. 1) is deployed as described with reference to presentation device deployed function 256 (FIG. 2A).

Then in a step 406, a determination for an auction is performed.

Illustrations associated with performing an auction are described with reference to advertising process auction column 204 (FIG. 2A).

For a determination of performing an auction in step 406, in a step 407, product/service provider posts advertising content as described with reference to post advertisement function 220 (FIG. 2A).

Then in a step 408, product/service provider 118 (FIG. 1) purchases tokens as described with reference to purchase tokens function 222 (FIG. 2A).

Then in a step 409, product/service provider transfers tokens as described with reference to transfer token function 224 (FIG. 2A).

Then in a step 411, server lists advertising content as described with reference to list advertisements function 232 (FIG. 2A).

Then in a step 412, marketer 120 (FIG. 1) searches advertising content as described with reference to search function 242 (FIG. 2A).

Then in a step 413, marketer 120 (FIG. 1) bids on advertising content as described with reference to bid function 244 (FIG. 2A).

Then in a step 414, server selects marketer 120 (FIG. 1) as described with reference to selection determination function 234 (FIG. 2A).

Then in a step 416, marketer downloads advertising content as described with reference to download advertisement function 246 (FIG. 2A).

Then in a step 417, advertising content is presented via presentation device 108 as described with reference to present advertising function 258 (FIG. 2A).

Then in a step 418, marketer 120 (FIG. 1) uploads tracking information associated with presentation of advertising as described with reference to upload tracking information function 248 (FIG. 2A).

Then in a step 419, server performs verification and transfers tokens as described with reference to verification/transfer function 236 (FIG. 2A).

Then in a step 421, marketer 120 (FIG. 1) exchanges tokens for currency as described with reference to exchange token function 250 (FIG. 2A).

Referring to FIG. 4B, following step 421 (FIG. 4A) or a determination of not an auction in step 406 (FIG. 4A), in a step 422 a determination for broker processing is performed.

Broker processing is illustrated with reference to advertising process column 208 (FIG. 2A).

For a determination of performing broker processing in step 422, in a step 423, product/service provider 118 (FIG. 1) posts advertising content as described with reference to post advertisement function 226 (FIG. 2A).

Then in a step 424, product/service provider 118 (FIG. 1) purchases tokens as described with reference to purchase tokens function 222 (FIG. 2A).

Then in a step 426, product/service provider 118 (FIG. 1) transfers tokens as described with reference to transfer token function 224 (FIG. 2A).

Then in a step 427, marketer 120 (FIG. 1) post venue as described with reference to post venue function 252 (FIG. 2A).

Then in a step 428, server performs a match as described with reference to match function 238 (FIG. 2A).

Then in a step 429, marketer 120 (FIG. 1) downloads advertising content as described with reference to receive advertisement function 254 (FIG. 2A).

Then in a step 431, advertising content is presented for viewing as described with reference to present advertising function 258 (FIG. 2A).

Then in a step 432, marketer 120 (FIG. 1) uploads tracking information as described with reference to upload tracking information function 248 (FIG. 2A).

Then in a step 433, server portion 106 (FIG. 1) performs verification and transfers tokens as described with reference to verification/transfer function 236 (FIG. 2A).

Then in a step 434, tokens are exchanged for currency as described with reference to exchange token function 250 (FIG. 2A).

Referring to FIG. 4C, following step 434 (FIG. 4B) or a determination for not a broker in step 422 (FIG. 4B), in a step 436 a determination for marketer selection is performed.

Marketer selection is illustrated with reference to advertising process column 260 (FIG. 2B).

For a determination of marketer selection in step 436, in a step 437, product/service provider 118 (FIG. 1) posts advertising as described with reference to post advertising function 264 (FIG. 2B).

Then in a step 438, product/service provider 118 (FIG. 1) purchases tokens as described with reference to purchase tokens function 222 (FIG. 2B).

Then in a step 439, product/service provider 118 (FIG. 1) transfers tokens as described with reference to transfer token function 224 (FIG. 2B).

Then in a step 441, server portion 106 (FIG. 1) lists advertising content as described with reference to list advertisement function 268 (FIG. 2B).

Then in a step 442, marketer 120 (FIG. 1) searches advertising content as described with reference to search function 276 (FIG. 2B).

Then in a step 443, marketer 120 (FIG. 1) accepts advertising content as described with reference to acceptance function 278 (FIG. 2B).

Then in a step 444, server portion 106 (FIG. 1) performs verification as described with reference to verify function 270 (FIG. 2B).

Then in a step 446, marketer 120 (FIG. 1) downloads advertising content as described with reference to download advertisement 280 (FIG. 2B).

Then in a step 447, advertising content is presented for viewing as described with reference to present advertising function 258 (FIG. 2B).

Then in a step 448, marketer 120 (FIG. 1) uploads tracking information as described with reference to upload tracking information function 248 (FIG. 2B).

Then in a step 449, server performs verification and transfers tokens as described with reference to verification/transfer function 236 (FIG. 2B).

Then in a step 451, marketer 120 (FIG. 1) exchanges tokens for currency as described with reference to exchange token function 250 (FIG. 2B).

Referring to FIG. 4D, following step 451 (FIG. 4C) or a determination for not marketer selection in step 436 (FIG. 4C), in a step 452 a determination for product/service provider selection is performed.

Product/service provider selection is illustrated with reference to advertising process column 262 (FIG. 2B).

For a determination of provider selection in step 452, in a step 453 marketer 120 posts venue as described with reference to post advertisement function 284 (FIG. 2B).

Then in a step 454, server portion 106 (FIG. 1) lists venues as described with reference to list function 274 (FIG. 2B).

Then in a step 456, product/service provider 118 (FIG. 1) purchases tokens as described with reference to purchase tokens function 222 (FIG. 2B).

Then in a step 457, product/service provider 118 (FIG. 1) transfers tokens as described with reference to transfer token function 224 (FIG. 2B).

Then in a step 458, product/service provider 118 (FIG. 1) searches venues and selected venues as described with reference to search function 266 (FIG. 2B).

Then in a step 459, server portion 106 (FIG. 1) confirms match as described with reference to confirmation function 272 (FIG. 2B).

Then in a step 461, marketer 120 (FIG. 1) downloads advertising content as described with reference to receive advertisement function 282 (FIG. 2B).

Then in a step 462, advertising content is presented for viewing as described with reference to present advertising function 258 (FIG. 2B).

Then in a step 463, marketer 120 (FIG. 1) uploads tracking information as described with reference to upload tracking information function 248 (FIG. 2B).

Then in a step 464, server portion 106 (FIG. 1) performs verification and transfers tokens as described with reference to verification/transfer function 236 (FIG. 2B).

Then in a step 466, tokens are exchanged for currency as described with reference to exchange token function 250 (FIG. 2B).

Referring to FIG. 4E, then following step 466 (FIG. 4D) and for a determination of not provider selection in step 452 (FIG. 4D), in a step 467 a determination for predetermined rate is performed.

Predetermined rate is illustrated with reference to advertising process column 302 (FIG. 3).

For a determination of predetermined rate in step 467, in a step 468 product/service provider 118 (FIG. 1) posts advertising content as described with reference to post advertising function 306 (FIG. 3).

Then in a step 469, product/service provider deposits funds as described with reference to deposit funds function 308 (FIG. 3).

Then in a step 471, marketer 120 performs registration as described with reference to register function 314 (FIG. 3).

Then in a step 472, server portion 106 (FIG. 1) performs match as described with reference to match function 310 (FIG. 3).

Then in a step 473, marketer 120 (FIG. 1) downloads advertising content as described with reference to download advertising function 316 (FIG. 3).

Then in a step 474, advertising content is provide as described with reference to present advertising function 258 (FIG. 3).

Then in a step 476, marketer 120 (FIG. 1) uploads tracking information as described with reference to upload tracking information 320 (FIG. 3).

Then in a step 477 server portion 106 (FIG. 1) transfers funds as described with reference to verify function 312 (FIG. 3).

Then in a step 478, marketer 120 (FIG. 1) transfers funds as described with reference to transfer funds function 318 (FIG. 3).

Following step 478 or a determination for not provider selection in step 452 (FIG. 4D), execution of method 400 terminates in a step 479.

FIGS. 4A-E illustrate an example method for the communication system as described with reference to FIGS. 1-3 where product/service providers may advertise their products via marketers and associated presentation devices.

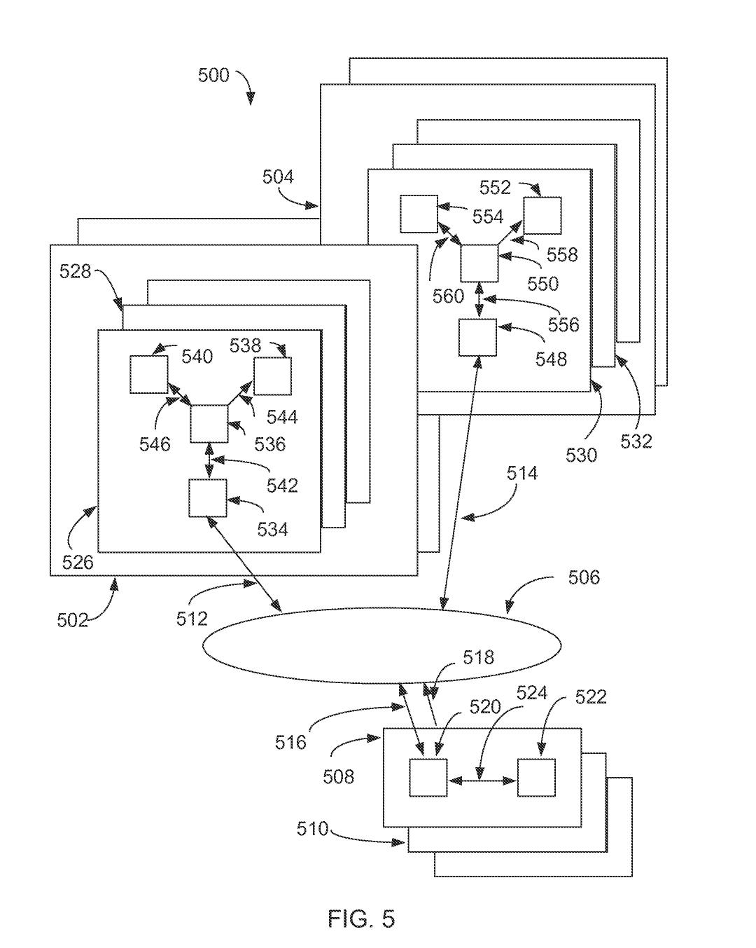

FIG. 5 illustrates a block diagram depicting a conventional client/server communication system.

A communication system 500 includes a multiplicity of networked regions with a sampling of regions denoted as a network region 502 and a network region 504, a global network 506 and a multiplicity of servers with a sampling of servers denoted as a server device 508 and a server device 510.

Network region 502 and network region 504 may operate to represent a network contained within a geographical area or region. Non-limiting examples of representations for the geographical areas for the networked regions may include postal zip codes, telephone area codes, states, counties, cities and countries. Elements within network region 502 and 504 may operate to communicate with external elements within other networked regions or within elements contained within the same network region.

In some implementations, global network 506 may operate as the Internet. It will be understood by those skilled in the art that communication system 500 may take many different forms. Non-limiting examples of forms for communication system 500 include local area networks (LANs), wide area networks (WANs), wired telephone networks, cellular telephone networks or any other network supporting data communication between respective entities via hardwired or wireless communication networks. Global network 506 may operate to transfer information between the various networked elements.

Server device 508 and server device 510 may operate to execute software instructions, store information, support database operations and communicate with other networked elements. Non-limiting examples of software and scripting languages which may be executed on server device 508 and server device 510 include C, C++, C# and Java.

Network region 502 may operate to communicate bi-directionally with global network 506 via a communication channel 512. Network region 504 may operate to communicate bi-directionally with global network 506 via a communication channel 514. Server device 508 may operate to communicate bi-directionally with global network 506 via a communication channel 516. Server device 510 may operate to communicate bi-directionally with global network 506 via a communication channel 518. Network region 502 and 504, global network 506 and server devices 508 and 510 may operate to communicate bi-directionally and also communicate bi-directionally with other networked device located within communication system 500.

Server device 508 includes a networking device 520 and a server 522. Networking device 520 may operate to communicate bi-directionally with global network 506 via communication channel 516 and with server 522 via a communication channel 524. Server 522 may operate to execute software instructions and store information.

Network region 502 includes a multiplicity of clients with a sampling denoted as a client 526 and a client 528. Client 526 includes a networking device 534, a processor 536, a GUI 538 and an interface device 540. Non-limiting examples of devices for GUI 538 include monitors, televisions, cellular telephones, smartphones and PDAs (Personal Digital Assistants). Non-limiting examples of interface device 540 include pointing device, mouse, trackball, scanner and printer. Networking device 534 may communicate bi-directionally with global network 506 via communication channel 512 and with processor 536 via a communication channel 542. GUI 538 may receive information from processor 536 via a communication channel 544 for presentation to a user for viewing. Interface device 540 may operate to send control information to processor 536 and to receive information from processor 536 via a communication channel 546. Network region 504 includes a multiplicity of clients with a sampling denoted as a client 530 and a client 532. Client 530 includes a networking device 548, a processor 550, a GUI 552 and an interface device 554. Non-limiting examples of devices for GUI 538 include monitors, televisions, cellular telephones, smartphones and PDAs (Personal Digital Assistants). Non-limiting examples of interface device 540 include pointing devices, mousse, trackballs, scanners and printers. Networking device 548 may communicate bi-directionally with global network 506 via communication channel 514 and with processor 550 via a communication channel 556. GUI 552 may receive information from processor 550 via a communication channel 558 for presentation to a user for viewing. Interface device 554 may operate to send control information to processor 550 and to receive information from processor 550 via a communication channel 560.

For example, consider the case where a user interfacing with client 526 may want to execute a networked application. A user may enter the IP (Internet Protocol) address for the networked application using interface device 540. The IP address information may be communicated to processor 536 via communication channel 546. Processor 536 may then communicate the IP address information to networking device 534 via communication channel 542. Networking device 534 may then communicate the IP address information to global network 506 via communication channel 512. Global network 506 may then communicate the IP address information to networking device 520 of server device 508 via communication channel 516. Networking device 520 may then communicate the IP address information to server 522 via communication channel 524. Server 522 may receive the IP address information and after processing the IP address information may communicate return information to networking device 520 via communication channel 524. Networking device 520 may communicate the return information to global network 506 via communication channel 516. Global network 506 may communicate the return information to networking device 534 via communication channel 512. Networking device 534 may communicate the return information to processor 536 via communication channel 542. Processor 536 may communicate the return information to GUI 538 via communication channel 544. User may then view the return information on GUI 538.

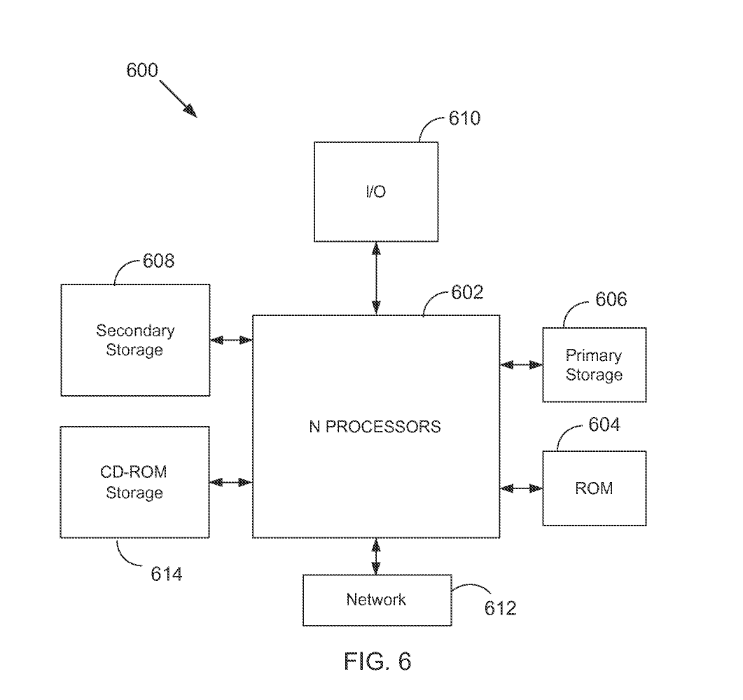

FIG. 6 illustrates a typical computer system that, when appropriately configured or designed, may serve as a computer system 600 for which the present invention may be embodied.

Computer system 600 includes a quantity of processors 602 (also referred to as central processing units, or CPUs) that may be coupled to storage devices including a primary storage 606 (typically a random access memory, or RAM), a primary storage 604 (typically a read-only memory, or ROM). CPU 602 may be of various types including micro-controllers (e.g., with embedded RAM/ROM) and microprocessors such as programmable devices (e.g., RISC or SISC based, or CPLDs and FPGAs) and devices not capable of being programmed such as gate array ASICs (Application Specific Integrated Circuits) or general purpose microprocessors. As is well known in the art, primary storage 604 acts to transfer data and instructions uni-directionally to the CPU and primary storage 606 typically may be used to transfer data and instructions in a bi-directional manner. The primary storage devices discussed previously may include any suitable computer-readable media such as those described above. A mass storage device 608 may also be coupled bi-directionally to CPU 602 and provides additional data storage capacity and may include any of the computer-readable media described above. Mass storage device 608 may be used to store programs, data and the like and typically may be used as a secondary storage medium such as a hard disk. It will be appreciated that the information retained within mass storage device 608, may, in appropriate cases, be incorporated in standard fashion as part of primary storage 606 as virtual memory. A specific mass storage device such as a CD-ROM 614 may also pass data uni-directionally to the CPU.

CPU 602 may also be coupled to an interface 610 that connects to one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 602 optionally may be coupled to an external device such as a database or a computer or telecommunications or internet network using an external connection shown generally as a network 612, which may be implemented as a hardwired or wireless communications link using suitable conventional technologies. With such a connection, the CPU might receive information from the network, or might output information to the network in the course of performing the method steps described in the teachings of the present invention.

Those skilled in the art will readily recognize, in light of and in accordance with the teachings of the present invention, that any of the foregoing steps and/or system modules may be suitably replaced, reordered, removed and additional steps and/or system modules may be inserted depending upon the needs of the particular application, and that the systems of the foregoing embodiments may be implemented using any of a wide variety of suitable processes and system modules, and is not limited to any particular computer hardware, software, middleware, firmware, microcode and the like. For any method steps described in the present application that can be carried out on a computing machine, a typical computer system can, when appropriately configured or designed, serve as a computer system in which those aspects of the invention may be embodied.

It will be further apparent to those skilled in the art that at least a portion of the novel method steps and/or system components of the present invention may be practiced and/or located in location(s) possibly outside the jurisdiction of the United States of America (USA), whereby it will be accordingly readily recognized that at least a subset of the novel method steps and/or system components in the foregoing embodiments must be practiced within the jurisdiction of the USA for the benefit of an entity therein or to achieve an object of the present invention. Thus, some alternate embodiments of the present invention may be configured to comprise a smaller subset of the foregoing means for and/or steps described that the applications designer will selectively decide, depending upon the practical considerations of the particular implementation, to carry out and/or locate within the jurisdiction of the USA. For example, any of the foregoing described method steps and/or system components which may be performed remotely over a network (e.g., without limitation, a remotely located server) may be performed and/or located outside of the jurisdiction of the USA while the remaining method steps and/or system components (e.g., without limitation, a locally located client) of the forgoing embodiments are typically required to be located/performed in the USA for practical considerations. In client-server architectures, a remotely located server typically generates and transmits required information to a US based client, for use according to the teachings of the present invention. Depending upon the needs of the particular application, it will be readily apparent to those skilled in the art, in light of the teachings of the present invention, which aspects of the present invention can or should be located locally and which can or should be located remotely. Thus, for any claims construction of the following claim limitations that are construed under 35 USC §112 (6) it is intended that the corresponding means for and/or steps for carrying out the claimed function are the ones that are locally implemented within the jurisdiction of the USA, while the remaining aspect(s) performed or located remotely outside the USA are not intended to be construed under 35 USC §112 (6). In some embodiments, the methods and/or system components which may be located and/or performed remotely include, without limitation: servers and global network.

It is noted that according to USA law, all claims must be set forth as a coherent, cooperating set of limitations that work in functional combination to achieve a useful result as a whole. Accordingly, for any claim having functional limitations interpreted under 35 USC §112 (6) where the embodiment in question is implemented as a client-server system with a remote server located outside of the USA, each such recited function is intended to mean the function of combining, in a logical manner, the information of that claim limitation with at least one other limitation of the claim. For example, in client-server systems where certain information claimed under 35 USC §112 (6) is/(are) dependent on one or more remote servers located outside the USA, it is intended that each such recited function under 35 USC §112 (6) is to be interpreted as the function of the local system receiving the remotely generated information required by a locally implemented claim limitation, wherein the structures and or steps which enable, and breath life into the expression of such functions claimed under 35 USC §112 (6) are the corresponding steps and/or means located within the jurisdiction of the USA that receive and deliver that information to the client (e.g., without limitation, client-side processing and transmission networks in the USA). When this application is prosecuted or patented under a jurisdiction other than the USA, then “USA” in the foregoing should be replaced with the pertinent country or countries or legal organization(s) having enforceable patent infringement jurisdiction over the present application, and “35 USC §112 (6)” should be replaced with the closest corresponding statute in the patent laws of such pertinent country or countries or legal organization(s).

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Having fully described at least one embodiment of the present invention, other equivalent or alternative methods of a communication system for advertising according to the present invention will be apparent to those skilled in the art. The invention has been described above by way of illustration, and the specific embodiments disclosed are not intended to limit the invention to the particular forms disclosed. For example, the particular implementation of the control unit may vary depending upon the particular type used. The control units described in the foregoing were directed to wireless implementations; however, similar techniques using optical implementations of the present invention are contemplated as within the scope of the present invention. The invention is thus to cover all modifications, equivalents, and alternatives falling within the spirit and scope of the following claims.

Claim elements and steps herein may have been numbered and/or lettered solely as an aid in readability and understanding. Any such numbering and lettering in itself is not intended to and should not be taken to indicate the ordering of elements and/or steps in the claims.

What is claimed is:

1. A method comprising the steps of:
communicating, to a server, a registration from at least one provider, the registration at least comprising an identity for the provider, an advertisement content, a geographical location for displaying the advertisement content, and a time period for an advertising event to display the advertisement content;
communicating, to the server, a deposit request from the provider, in which the server deposits funds into an account for the advertising event;
communicating, to the server, a registration from at least one marketer, the registration at least comprising an identity for the marketer, an identity of at least one display and control device in possession of the marketer, a geographical location for the display and control device, and an available time period for displaying advertisement content, the display and control device at least comprising a presentation device being configured to display at least advertising content in public view, means for determining a location of the display and control device, and a control unit at least being operable to control the presentation device, track location of the display and control device, track a time duration for a displayed advertisement content, and communicate over a network; and
receiving, from the server, notification of a match of a marketer to present advertisement content of a provider, in which the server: transmits the matched provider's advertisement content for communication over the network to the matched marketer's display and control device; receives tracking information for the matched marketer's display and control device; determines a value of funds, at least in part determined by the tracking information; and transfers the value of funds from the matched provider's account for the advertising event to an account for the matched marketer.

2. The method as recited in claim 1, in which the funds comprise tokens purchased by the provider.

3. The method as recited in claim 2, in which a purchase cost of a token is greater than a value of the token.

4. The method as recited in claim 3, in which a token represents a unit of advertising time.

5. The method as recited in claim 1, in which a plurality of provider registrations and a plurality of marketer registrations are communicated to the server.

6. The method as recited in claim 5, in which a plurality of marketers are matched to at least one provider.

7. The method as recited in claim 5, in which a plurality of providers are matched to at least one marketer.

8. The method as recited in claim 5, further comprising the step of communicating, to the server, a bid, from at least one marketer, for presenting advertisement content of a provider, and the matching is at least, in part, determined by the bid.

9. A system comprising:
a server;
a plurality of presentation units each at least comprising a presentation device being configured to display at least advertising content in public view, means for determining a location of said presentation unit, and a control unit at least being operable to control the presentation device, track location of said presentation unit, track a time duration for a displayed advertisement content, and communicate over a network, at least one of said presentation units being joined to a vehicle to be driven about a geographical location; and
a client being in communication with said server, said client being operable to: communicate registrations from a plurality of providers, each registration at least comprising an identity for the provider, an advertisement content, a geographical location for displaying the advertisement content, and a time period for an advertising event to display the advertisement content; communicate a deposit requests from the providers, in which said server deposits funds into an accounts for the advertising events; communicate registrations from a plurality of marketers, each registration at least comprising an identity for the marketer, an identity of at least presentation unit in possession of the marketer, a geographical location for said presentation unit, and an available time period for displaying advertisement content; and receive notification of a match of at least one marketer to present advertisement content of at least one provider, in which the server is operable to: transmit the matched provider's advertisement content for communication over the network to the matched marketer's presentation unit; receive tracking information for the matched marketer's presentation unit; determine a value of funds, at least in part determined by the tracking information; and transfer the value of funds from the matched provider's account for the advertising event to an account for the matched marketer.

10. The system as recited in claim 9, in which a plurality of providers are matched to at least one marketer, a plurality of marketers are matched to at least one provider, and the funds comprise tokens purchased by the provider with a purchase cost of a token being greater than a value of the token where a token represents an unit of advertising time.

11. The system as recited in claim 9, in which said client is further operable to communicate bids, from marketers, for presenting advertisement content of a provider and the matching is at least, in part, determined by the bids.

12. The system as recited in claim 9, in which value of a token is fixed.

13. A non-transitory computer-readable storage medium with an executable program stored thereon, wherein the program instructs a processor to perform the following steps:
communicating, to a server, a registration from at least one provider, the registration at least comprising an identity for the provider, an advertisement content, a geographical location for displaying the advertisement content, and a time period for an advertising event to display the advertisement content;
communicating, to the server, a deposit request from the provider, in which the server deposits funds into an account for the advertising event;
communicating, to the server, a registration from at least one marketer, the registration at least comprising an identity for the marketer, an identity of at least one display and control device in possession of the marketer, a geographical location for the display and control device, and an available time period for displaying advertisement content, the display and control device at least comprising a presentation device being configured to display at least advertising content in public view, means for determining a location of the display and control device, and a control unit at least being operable to control the presentation device, track location of the display and control device, track a time duration for a displayed advertisement content, and communicate over a network; and
receiving, from the server, notification of a match of a marketer to present advertisement content of a provider, in which the server: transmits the matched provider's advertisement content for communication over the network to the matched marketer's display and control device; receives tracking information for the matched marketer's display and control device; determines a value of funds, at least in part determined by the tracking information; and transfers the value of funds from the matched provider's account for the advertising event to an account for the matched marketer.

14. The program instructing the processor as recited in claim 13, in which the funds comprise tokens purchased by the provider where a purchase cost of a token is greater than a value of the token and a token represents a unit of advertising time.

15. The program instructing the processor as recited in claim 13, in which a plurality of provider registrations and a plurality of marketer registrations are communicated to the server.

16. The program instructing the processor as recited in claim 15, in which a plurality of marketers are matched to at least one provider.

17. The program instructing the processor as recited in claim 15, in which a plurality of providers are matched to at least one marketer.

18. The program instructing the processor as recited in claim 15, further comprising the step of communicating, to the server, a bid, from at least one marketer, for presenting advertisement content of a provider, and the matching is at least, in part, determined by the bid.

19. The program instructing the processor as recited in claim 13, in which the display and control device is joined to a vehicle.

20. The program instructing the processor as recited in claim 13, in which value of a token is fixed.
